(19) United States
(12) Patent Application Publication
(10) Pub. No.: US 2022/0215449 A1
(43) Pub. Date: Jul. 7, 2022

(54) PARTS CONFIGURATION PLAN GENERATION DEVICE, PARTS CONFIGURATION PLAN GENERATION METHOD, AND NON-TRANSITORY COMPUTER READABLE MEDIUM

(71) Applicant: NEC Corporation, Tokyo (JP)

(72) Inventors: Kazuki TANABE, Tokyo (JP); Kozo Satoda, Tokyo (JP); Takayuki Kuroda, Tokyo (JP); Yutaka Yakuwa, Tokyo (JP); Takuya Kuwahara, Tokyo (JP); Tatsuya Fukuda, Tokyo (JP); Takashi Maruyama, Tokyo (JP)

(73) Assignee: NEC Corporation, Tokyo (JP)

(21) Appl. No.: 17/562,335

(22) Filed: Dec. 27, 2021

(30) Foreign Application Priority Data
Jan. 5, 2021 (JP) 2021-000398

(51) Int. Cl. G06Q 30/06

(52) U.S. Cl. CPC G06Q 30/0621

(57) ABSTRACT

In a parts configuration plan generation device, a concretization processing unit (first concretization unit) concretizes an “abstract configuration” by using a first concretization pattern, and thereby generates a “base parts configuration”. A concretization processing unit (second concretization unit) applies a second concretization pattern to the base parts configuration and concretizes a parts item contained in the base parts configuration, and thereby generates a “candidate parts configuration”. An output unit outputs, as a “parts configuration plan”, the candidate parts configuration where concretization is done and satisfying a condition to be satisfied by a device to be built.

### INCORPORATION BY REFERENCE

This application is based upon and claims the benefit of priority from Japanese patent application No. 2021-000398, filed on Jan. 5, 2021, the disclosure of which is incorporated herein in its entirety by reference.

### TECHNICAL FIELD

The present disclosure relates to a parts configuration plan generation device, a parts configuration plan generation method, and a control program.

### BACKGROUND ART

An ordering system capable of receiving an order that individually specifies parts of a personal computer, which is a device to be built, to build an assembled and completed personal computer has been proposed (for example, Japanese Unexamined Patent Application Publication No. 2001-297232).

The present inventor has found needs for generating a parts configuration plan of a device to be built that satisfies requests and conditions by a user with less burden on the user.

### SUMMARY

An object of the present disclosure is to provide a parts configuration plan generation device, a parts configuration plan generation method, and a control program capable of generating a parts configuration plan of a device to be built that satisfies requests and conditions by a user with less burden on the user.

A parts configuration plan generation device according to a first aspect includes a first concretization unit configured to concretize an abstract configuration containing an entry regarding a request for a device to be built by using a first concretization pattern, and thereby generate a base parts configuration; a second concretization unit configured to apply a second concretization pattern to the base parts configuration and concretize a parts item contained in the base parts configuration, and thereby generate a candidate parts configuration; and an output unit configured to output, as a parts configuration plan, the candidate parts configuration satisfying a condition to be satisfied by the device to be built.

A parts configuration plan generation method according to a second aspect includes concretizing an abstract configuration containing an entry regarding a request for a device to be built by using a first concretization pattern, and thereby generating a base parts configuration; applying a second concretization pattern to the base parts configuration and concretizing a parts item contained in the base parts configuration, and thereby generating a candidate parts configuration; and outputting, as a parts configuration plan, the parts configuration plan satisfying a condition to be satisfied by the device to be built.

A control program according to a third aspect causes a parts configuration plan generation device to execute a process including concretizing an abstract configuration containing an entry regarding a request for a device to be built by using a first concretization pattern, and thereby generating a base parts configuration; applying a second concretization pattern to the base parts configuration and concretizing a parts item contained in the base parts configuration, and thereby generating a candidate parts configuration; and outputting, as a parts configuration plan, the candidate parts configuration satisfying a condition to be satisfied by the device to be built.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram showing an example of a parts configuration plan generation device according to a first example embodiment;

FIG. 2 is a block diagram showing an example of a parts configuration plan generation device according to a second example embodiment;

FIG. 3 is a view showing an example of an abstract configuration;

FIG. 4 is a view showing an example of a condition;

FIG. 5 is a view showing an example of a type 1 concretization pattern;

FIG. 6 is a view illustrating addition of attribute information;

FIG. 7 is a view showing an example (specific example 1) of the data structure of a type 2 concretization pattern;

FIG. 8 is a view showing an example (specific example 2) of the data structure of a type 2 concretization pattern;

FIG. 9A is a view showing an example of the data structure of parts data;

FIG. 9B is a view showing an example of the data structure of parts data;

FIG. 9C is a view showing an example of the data structure of parts data;

FIG. 9D is a view showing an example of the data structure of parts data;

FIG. 10 is a flowchart showing an example of a processing operation of the parts configuration plan generation device according to the second example embodiment;

FIG. 11 is a view illustrating an example of concretization in the second example embodiment;

FIG. 12 is a view illustrating an example of concretization in the second example embodiment;

FIG. 13 is a view illustrating an example of concretization in the second example embodiment; and

FIG. 14 is a view showing a hardware configuration example of a parts configuration plan generation device.

### DESCRIPTION OF EMBODIMENTS

Example embodiments are described hereinafter with reference to the drawings. It should be noted that, in the example embodiments, the same or equivalent elements are denoted by the same reference symbols, and the redundant explanation thereof is omitted.

### First Example Embodiment

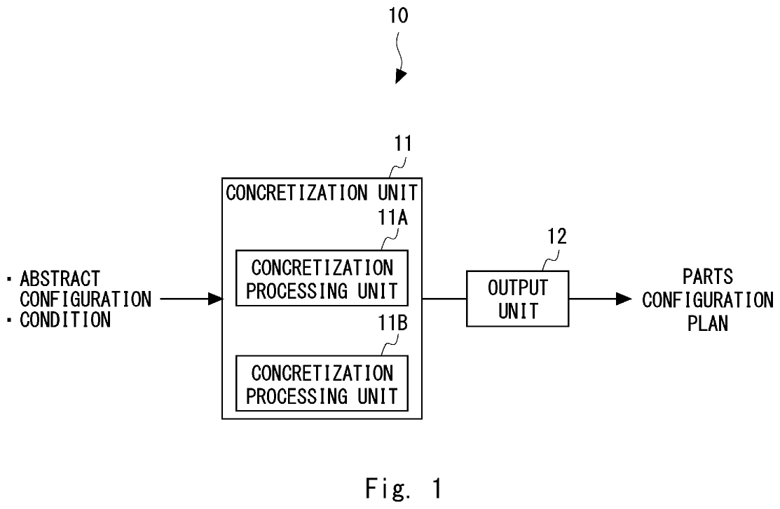

FIG. 1 is a block diagram showing an example of a parts configuration plan generation device according to a first example embodiment. In FIG. 1, a parts configuration plan generation device 10 includes a concretization unit 11 and an output unit 12.

The concretization unit 11 receives an “abstract configuration” and a “condition”. The “abstract configuration” contains an input value (request condition) of an entry regarding a request for a device to be built. The “entry regarding a request for a device to be built” is “use”, for example. When the device to be built is a personal computer, for example, the “use” may be “game”, “video editing”, “telework” or the like. The “condition” is a condition to be satisfied by the device to be built, and it may be a budget (cost), a size or the like, for example.

The concretization unit 11 includes a concretization processing unit (first concretization unit) 11A and a concretization processing unit (second concretization unit) 11B.

The concretization processing unit (first concretization unit) 11A concretizes the “abstract configuration” by using a concretization pattern (which is sometimes referred to hereinafter as a “type 1 concretization pattern”), and thereby generates a “base parts configuration”. The “type 1 concretization pattern” associates the “abstract configuration” with the “base parts configuration”. Specifically, a pattern for converting the “abstract configuration” into the “base parts configuration” is referred to as the “type 1 concretization pattern”. For example, when the “abstract configuration” contains the request condition “use=game”, the concretization processing unit 11A selects a type 1 concretization pattern corresponding to the request condition “use=game” from a plurality of type 1 concretization patterns respectively corresponding to a plurality of uses. Then, the concretization processing unit 11A concretizes the “abstract configuration” by using the selected type 1 concretization pattern and thereby generates the “base parts configuration”. The “base parts configuration” is composed of “abstract parts items” where parts to be included in a device to be built according to its use are represented in an abstract form, for example.

The concretization processing unit (second concretization unit) 11B applies a concretization pattern (which is sometimes referred to hereinafter as a “type 2 concretization pattern”) to the base parts configuration and concretizes the parts (abstract parts items) contained in the base parts configuration, and thereby generates a “candidate parts configuration”. The “candidate parts configuration” is a parts configuration where some or all of the abstract parts items contained in the “base parts configuration” are specified. The “type 2 concretization pattern” is a concretization pattern that converts an “abstract parts item” into a “concrete parts item”, a concretization pattern that concretizes the connection between two concrete parts items, and so on, for example.

The output unit 12 outputs, as a “parts configuration plan”, the candidate parts configuration where concretization is done and which satisfies the condition to be satisfied by the device to be built.

As described above, according to the first example embodiment, in the parts configuration plan generation device 10, the concretization processing unit (first concretization unit) 11A concretizes the “abstract configuration” by using the type 1 concretization pattern, and thereby generates the “base parts configuration”. The concretization processing unit (second concretization unit) 11B applies the type 2 concretization pattern to the base parts configuration and concretizes the parts items contained in the base parts configuration, and thereby generates the “candidate parts configuration”. The output unit 12 outputs the candidate parts configuration where concretization is done and which satisfies the condition to be satisfied by the device to be built as the “parts configuration plan”.

Since this configuration of the parts configuration plan generation device 10 eliminates the need for a user to individually specify parts, it reduces the burden on the user. Further, since it first concretizes the “abstract configuration” containing the request condition and then outputs the candidate parts configuration where concretization is done and which satisfies the condition to be satisfied by a device to be built as the “parts configuration plan”, it is capable of generating the parts configuration plan of the device to be built that satisfies the requests and conditions by the user.

### Second Example Embodiment

A second example embodiment relates to a more specific embodiment. In the second example embodiment, the case where a device to be built is a personal computer (PC) is described as an example.

### <Configuration Example of Parts Configuration Plan Generation Device>

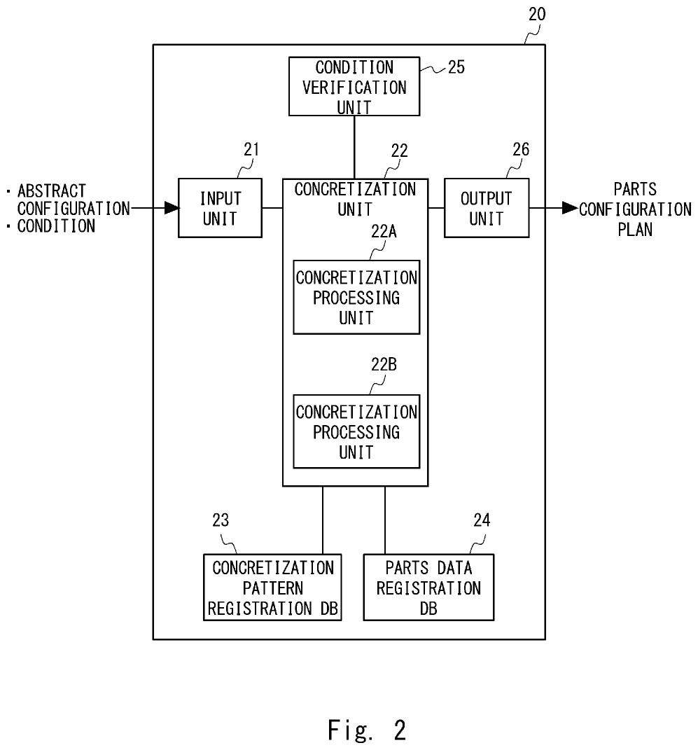

FIG. 2 is a block diagram showing an example of a parts configuration plan generation device according to a second example embodiment. In FIG. 2, a parts configuration plan generation device 20 includes an input unit 21, a concretization unit 22, a concretization pattern registration database (DB) 23, a parts data registration database (DB) 24, a condition verification unit 25, and an output unit 26.

The input unit 21 receives input of the “abstract configuration” and the “condition” from a terminal (not shown). The terminal (not shown) is a terminal used by a shop staff member, and it may be a mobile terminal or a stationary terminal. Further, the “abstract configuration” and the “condition” received by the input unit 21 may be automatically input by an external system (not shown) or the like, for example.

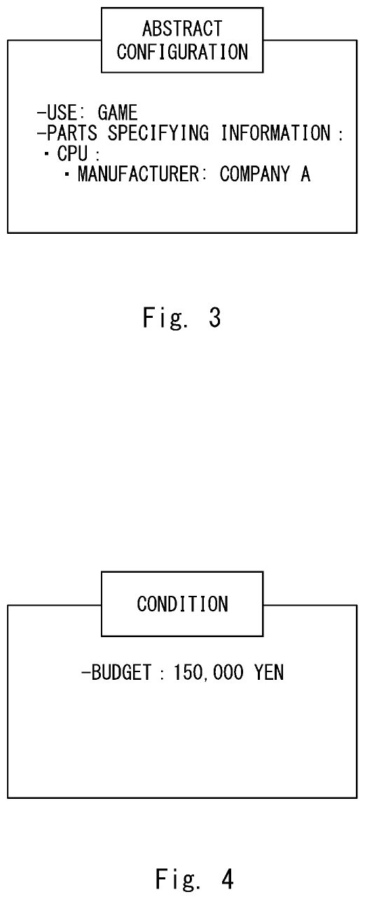

FIG. 3 is a view showing an example of the abstract configuration. FIG. 3 is a view conceptually illustrating the data structure of the abstract configuration, and data representing entries are associated with each other so as to satisfy the relationship of the entries illustrated by an example in this figure. The abstract configuration shown in FIG. 3 contains “use” as the “entry regarding a request”, and also contains “game” as an input value of the entry “use”. Further, the abstract configuration shown in FIG. 3 contains the entry “parts specifying information”, and contains “CPU: manufacturer: Company A” as an input value of the entry “parts specifying information”. FIG. 4 shows an example of the condition. FIG. 4 is a view conceptually illustrating the data structure of the condition, and data representing entries are associated with each other so as to satisfy the relationship of the entries illustrated by an example in this figure. The condition shown in FIG. 4 is “budget=150,000 yen”. Although FIGS. 3 and 4 are separate figures for the sake of convenience, the abstract configuration shown in FIG. 3 and the condition shown in FIG. 4 are linked with each other and input as a pair from the terminal (not shown).

Referring back to FIG. 2, the concretization unit 22 includes a concretization processing unit (first concretization unit) 22A and a concretization processing unit (second concretization unit) 22B.

The concretization processing unit (first concretization unit) 22A concretizes the “abstract configuration” by using the type 1 concretization pattern, and thereby generates the base parts configuration, just like the concretization processing unit 11A in the first example embodiment. For example, when the “abstract configuration” contains the request condition “use=game”, the concretization processing unit 22A selects a type 1 concretization pattern corresponding to the request condition “use=game” from a plurality of type 1 concretization patterns respectively corresponding to a plurality of uses. Then, the concretization processing unit 22A concretizes the “abstract configuration” by using the selected type 1 concretization pattern and thereby generates the “base parts configuration”. The type 1 concretization pattern is stored in the concretization pattern registration database (DB) 23.

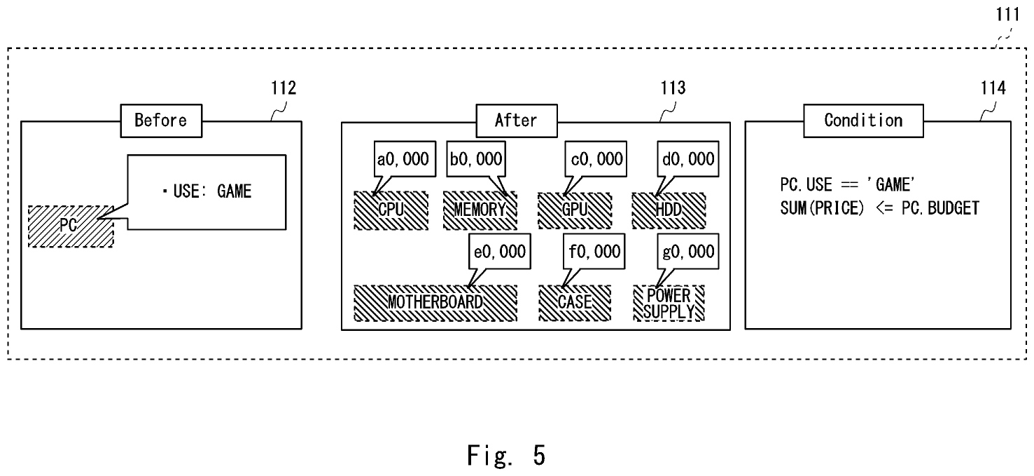

FIG. 5 is a view showing an example of the type 1 concretization pattern. FIG. 5 is a view conceptually illustrating the data structure of the type 1 concretization pattern, and in a database (memory, storage unit), data representing entries are associated with each other so as to satisfy the relationship of the entries illustrated by an example in this figure. In FIG. 5, a type 1 concretization pattern 111 contains information indicating a target of concretization (which is referred to hereinafter as a left part of the concretization pattern) 112, information indicating a configuration after concretization (which is referred to hereinafter as a right part of the concretization pattern) 113, and a template 114 for generating a condition to be added by concretization.

Referring back to FIG. 2, when a structure corresponding to the left part 112 of the concretization pattern is contained in the abstract configuration, the concretization processing unit 22A rewrites this structure with the structure (i.e., the base parts configuration) corresponding to the right part 113 of the concretization pattern. After this rewriting, the concretization processing unit 22A adds the condition generated by the template 114 to the condition linked with the abstract configuration.

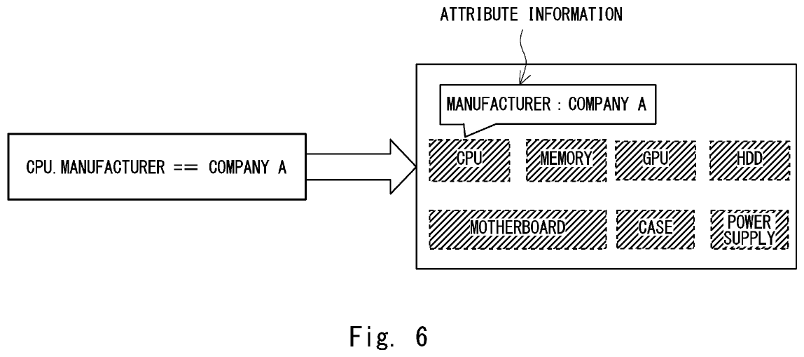

Further, when “additional information” such as parts specifying information is contained in the abstract configuration as shown in FIG. 3, the concretization processing unit 22A may add the details of the “additional information” to the abstract parts item contained in the generated base parts configuration and corresponding to the details of the “additional information” as “attribute information (attribute information regarding a parts item)” as shown in FIG. 6. FIG. 6 is a view illustrating addition of the attribute information.

The concretization processing unit (second concretization unit) 22B applies the type 2 concretization pattern to the base parts configuration and concretizes the abstract parts items contained in the base parts configuration, and thereby generates the candidate parts configuration, just like the concretization processing unit 11B in the first example embodiment. The concretization processing unit 22B may select the type 2 concretization pattern that matches the attribute information added to the abstract parts item.

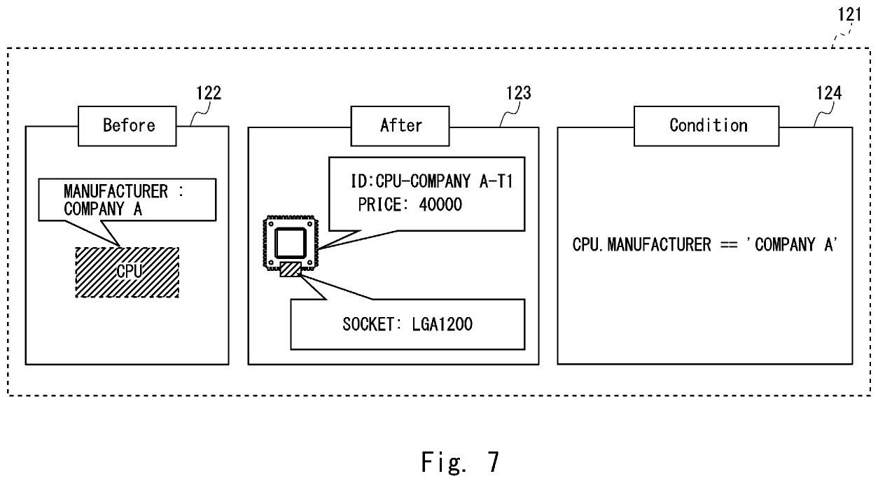

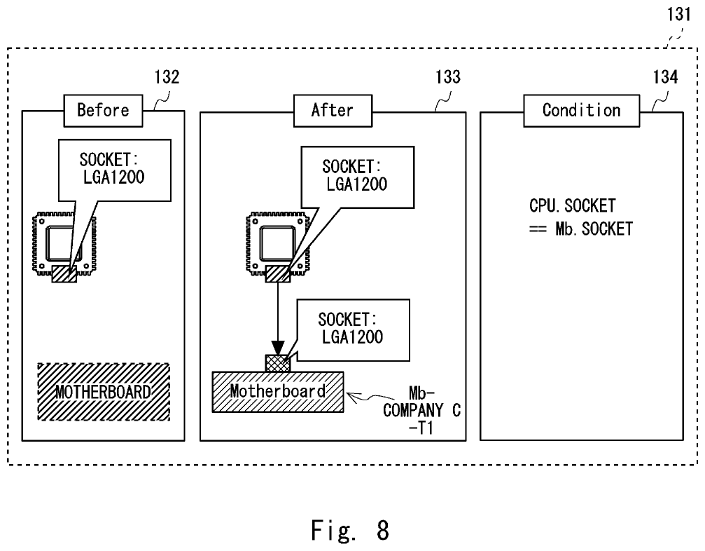

FIG. 7 is a view showing an example (specific example 1) of the data structure of the type 2 concretization pattern. FIG. 7 and FIG. 8, which is described later, are views conceptually illustrating the data structure of the concretization pattern, and in a database (memory, storage unit), data representing entries are associated with each other so as to satisfy the relationship of the entries illustrated by an example in this figure. A type 2 concretization pattern 121 shown in FIG. 7 contains “abstract parts item: CPU (manufacturer: Company A)” in the left part of the concretization pattern, and contains “concrete parts item: CPU (ID: CPU—Company A—T1, price: 40,000 yen), socket: LGA1200” in the right part. Specifically, the type 2 concretization pattern 121 is a concretization pattern for converting the abstract parts item (CPU) into the concrete parts item (CPU). In the case where a plurality of type 2 concretization patterns that contain the “abstract parts item: CPU (manufacturer: Company A)” in the left part are stored in the concretization pattern registration DB 23, the concretization processing unit 22B may select the type 2 concretization pattern with the highest “priority”, which is given in advance to each type 2 concretization pattern. The “priority” may be “sales priority” of a shop, for example. For example, a higher “sales priority” may be given to the corresponding type 2 concretization pattern as the stock quantity of the parts corresponding to the concrete parts item is greater.

FIG. 8 is a view showing an example (specific example 2) of the data structure of the type 2 concretization pattern. A type 2 concretization pattern 131 shown in FIG. 8 contains “concrete parts item (including unconcretized connection): CPU (ID: CPU—Company A—T1, price: 40,000 yen), socket: LGA1200” and “abstract parts item: motherboard” in a left part 132 of the concretization pattern. Further, the type 2 concretization pattern 131 contains “concrete parts item: CPU (ID: CPU—Company A—T1, price: 40,000 yen, socket: LGA1200), socket: LGA1200”, and “concrete parts item: ID: mb—Company C—T1, price: 25,000 yen, socket: LGA1200” connected thereto in a right part 133 of the concretization pattern. The use of this type 2 concretization pattern 131 enables concretization of an abstract parts item into a first concrete parts item, and concretization of the connection between a second concrete parts item and the first concrete parts item.

By applying the type 2 concretization pattern to the base parts configuration or the candidate parts configuration, the “condition” linked with the abstract configuration (i.e., the base parts configuration or the candidate parts configuration) is updated. For example, the “condition” shown in FIG. 5 contains the condition “total price of parts≤budget”. Thus, the concretization processing unit 22B may calculate the “total price (subtotal) of parts” each time the price of the parts item contained in the candidate parts configuration is specified, update the “condition” with the calculated value. Note that the concretization processing unit 22B may specify the price of the parts by referring to the parts data registration DB 24.

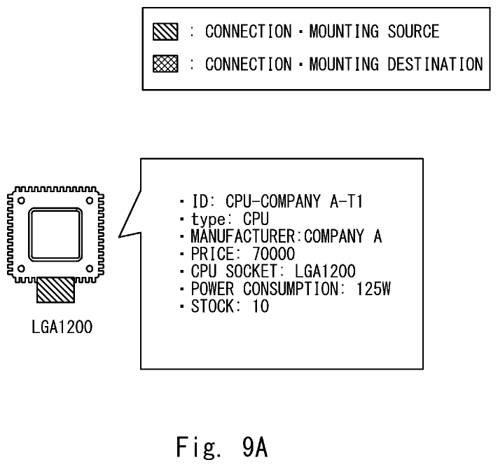

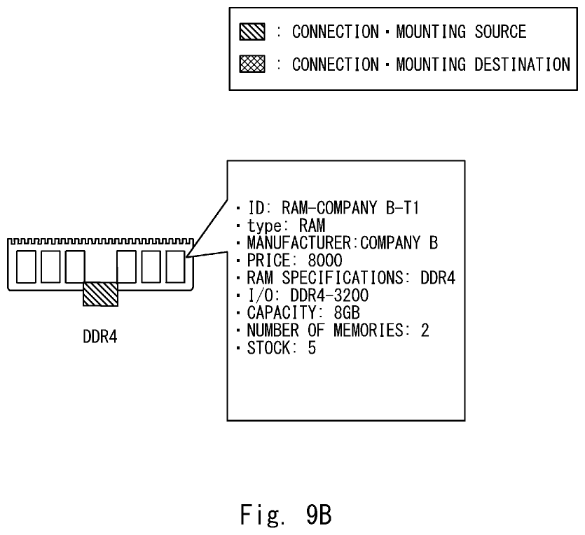

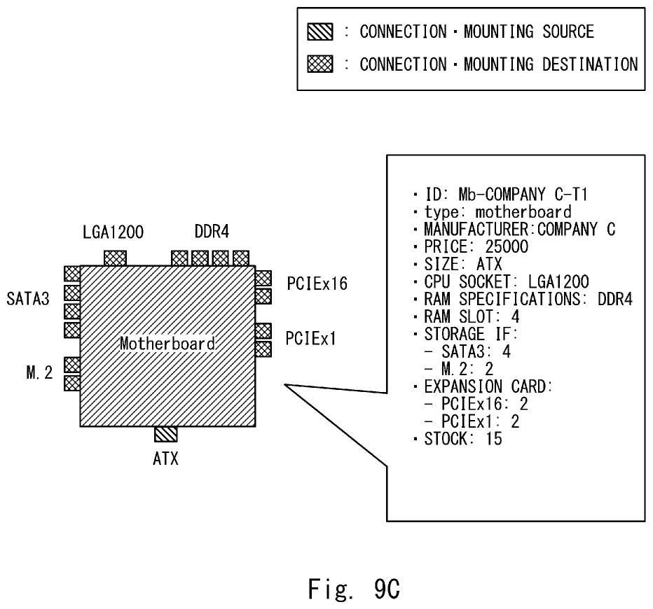

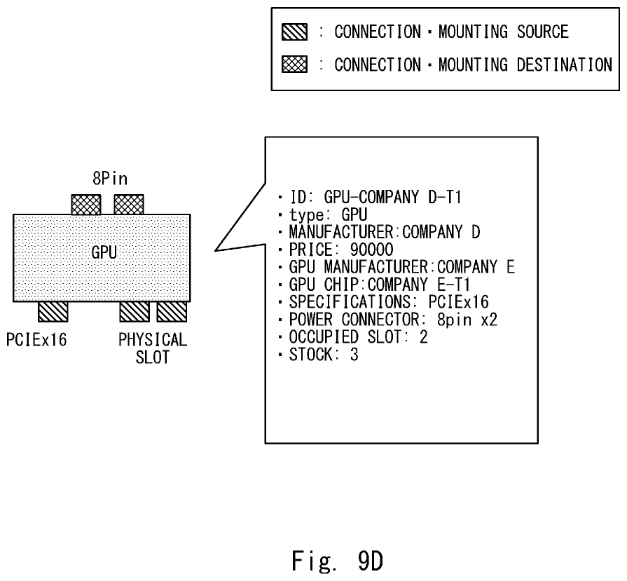

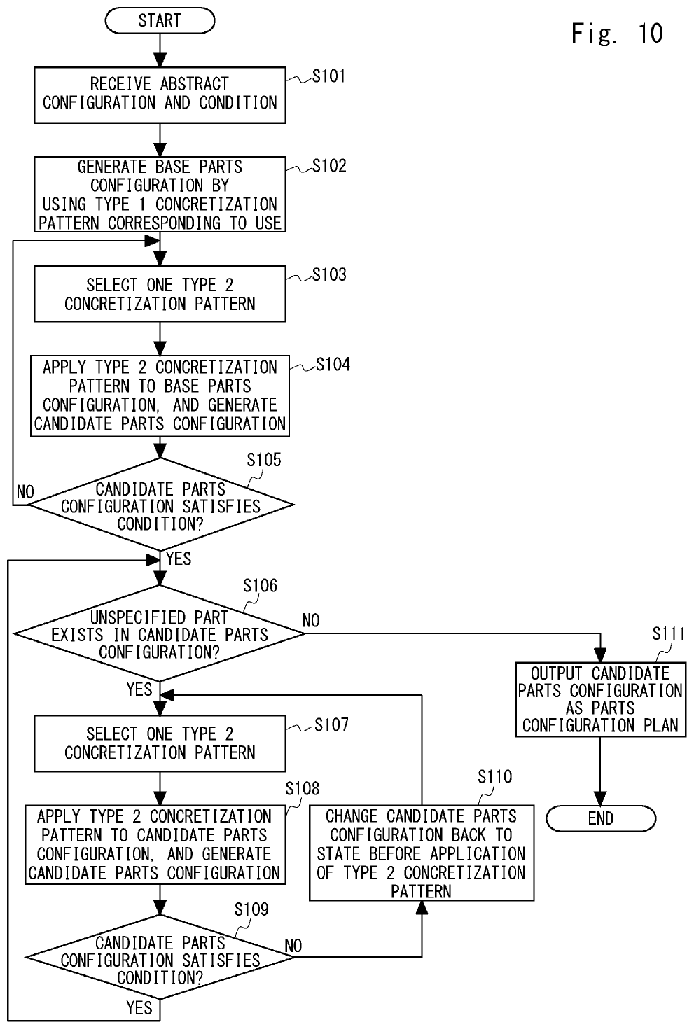

FIGS. 9A to 9D are views showing an example of the data structure of parts data. FIGS. 9A to 9D are views conceptually illustrating the data structure of parts data, and in a database (memory, storage unit), data representing entries are associated with each other so as to satisfy the relationship of the entries illustrated by an example in this figure. FIG. 9A shows an example of the structure of parts data of a CPU. The parts data shown in FIG. 9A is parts data for a CPU with “ID: CPU—Company A—T1”. The parts data shown in FIG. 9B is parts data for a RAM with “ID: RAM—Company B—T1”. The parts data shown in FIG. 9C is parts data for a motherboard with “ID: mb—Company C—T1”. The parts data shown in FIG. 9D is parts data for a GPU with “ID: GPU—Company D—T1”. The parts data shown in FIGS. 9A to 9D contain a terminal (connection ⋅ mounting source) and its type, and a terminal (connection ⋅ mounting destination) and its type. For example, the parts data of FIG. 9A contains the terminal (connection ⋅ mounting source) and its type (LGA1200).

Referring back to FIG. 2, the concretization processing unit 22B gives the concretized candidate parts configuration and condition to the condition verification unit 25, and requests verification as to whether the concretized candidate parts configuration satisfies the concretized condition or not. When a verification result shows that the condition is satisfied and there is no unspecified part in the candidate parts configuration, the concretization processing unit 22B passes the candidate parts configuration to the output unit 26. This candidate parts configuration is output as the parts configuration plan from the output unit 26.

On the other hand, when a verification result shows that the condition is satisfied and there is an unspecified part in the candidate parts configuration, the concretization processing unit 22B further applies the type 2 concretization pattern to the candidate parts configuration. When a verification result shows that the condition is not met, the concretization processing unit 22B changes the candidate parts configuration back to the candidate parts configuration before the type 2 concretization pattern is applied, and applies another type 2 concretization pattern to this candidate parts configuration.

The condition verification unit 25 receives the concretized candidate parts configuration and condition, and verifies whether the concretized candidate parts configuration satisfies the concretized condition, and returns a verification result to the concretization processing unit 22B.

### <Operation Example of Parts Configuration Plan Generation Device>

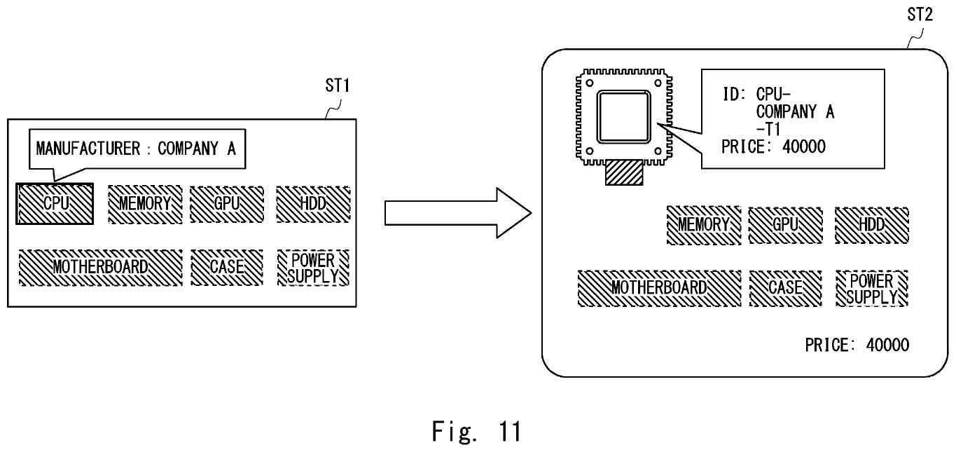

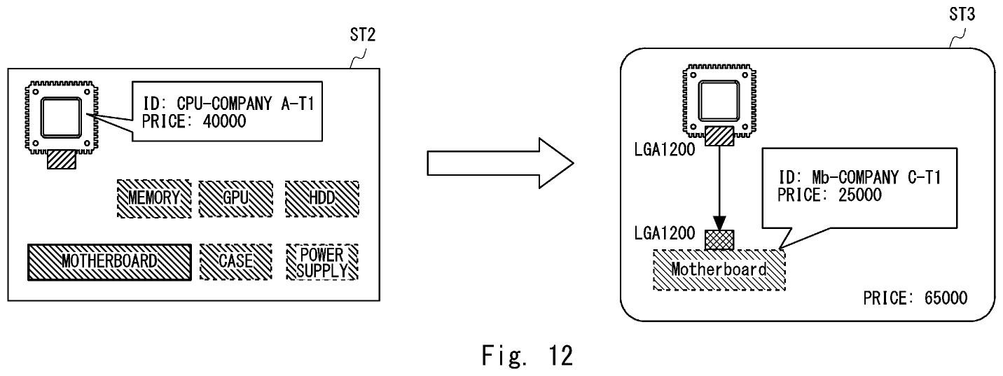

An example of the processing operation of the parts configuration plan generation device 20 having the above-described configuration is described hereinafter. FIG. 10 is a flowchart showing an example of the processing operation of the parts configuration plan generation device according to the second example embodiment. FIGS. 11 to 13 are views illustrating examples of concretization in the second example embodiment.

In the parts configuration plan generation device 20, the input unit 21 receives input of the “abstract configuration” and the “condition” (Step S101).

The concretization processing unit 22A concretizes the “abstract configuration” by using the type 1 concretization pattern corresponding to the use, and thereby generates the base parts configuration (Step S102). This base parts configuration has the configuration state ST1 in FIG. 11. As described earlier, when “additional information” such as parts specifying information is contained in the abstract configuration, the concretization processing unit 22A may add, as “attribute information”, the details of the “additional information” to the abstract parts item contained in the base parts configuration and corresponding to the details of the “additional information”.

The concretization processing unit 22A selects one type 2 concretization pattern to be applied to the base parts configuration (Step S103). As described above, when the attribute information is added to the abstract parts item, the concretization processing unit 22A selects the type 2 concretization pattern that matches this attribute information. Further, as described above, the concretization processing unit 22A may select the type 2 concretization pattern with the highest priority. It is assumed in this example that the type 2 concretization pattern shown in FIG. 7 is selected.

The concretization processing unit 22A applies the selected type 2 concretization pattern to the base parts configuration, and generates the candidate parts configuration (Step S104). The generated candidate parts configuration has the configuration state ST2 in FIG. 11. At this time, the “condition” is also concretized by the type 2 concretization pattern. The concretization processing unit 22A gives the generated candidate parts configuration and the condition to the condition verification unit 25, and requests verification as to whether the concretized candidate parts configuration satisfies the concretized condition or not.

When a verification result from the condition verification unit 25 shows that the candidate parts configuration satisfies the condition (Yes in Step S105), the concretization processing unit 22A determines whether there is an unspecified part in the candidate parts configuration (Step S106). When, on the other hand, a verification result from the condition verification unit 25 shows that the candidate parts configuration does not satisfy the condition (No in Step S105), the concretization processing unit 22A selects another type 2 concretization pattern (Step S103).

When there is an unspecified part in the candidate parts configuration (Yes in Step S106), the concretization processing unit 22A selects another type 2 concretization pattern (Step S107). As described above, the concretization processing unit 22A may select the type 2 concretization pattern with the highest priority. It is assumed in this example that the type 2 concretization pattern shown in FIG. 8 is selected.

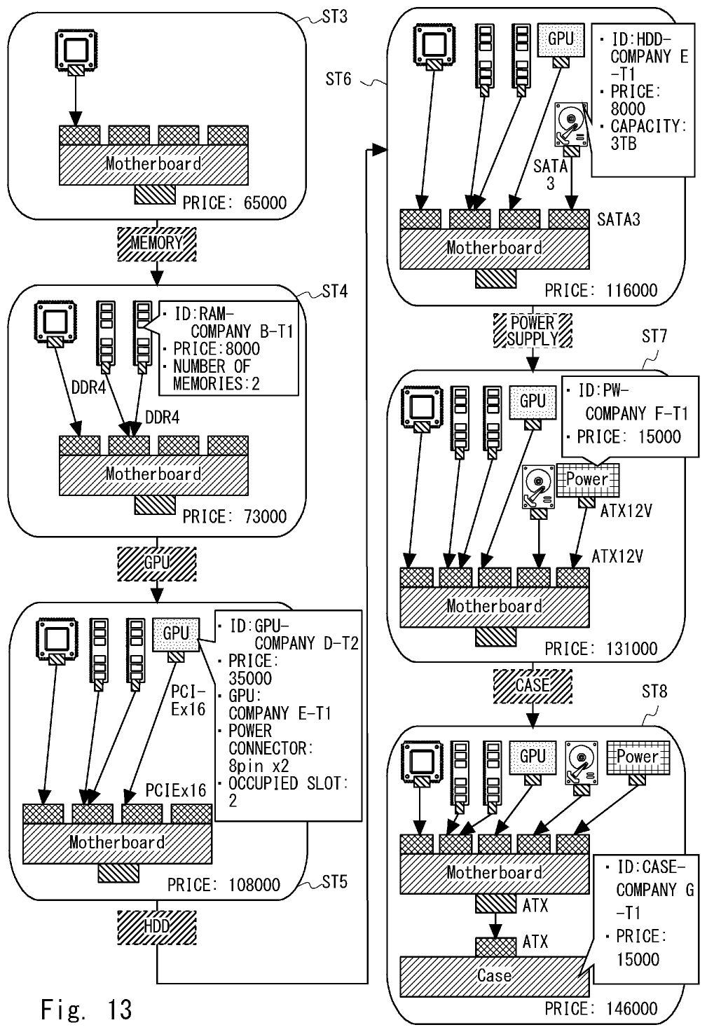

The concretization processing unit 22A applies the selected type 2 concretization pattern to the candidate parts configuration, and generates a candidate parts configuration (Step S108). The generated candidate parts configuration has the configuration state ST3 in FIG. 12. At this time, the “condition” is also concretized by the type 2 concretization pattern. The concretization processing unit 22A gives the generated candidate parts configuration and the condition to the condition verification unit 25, and requests verification as to whether the concretized candidate parts configuration satisfies the concretized condition or not.

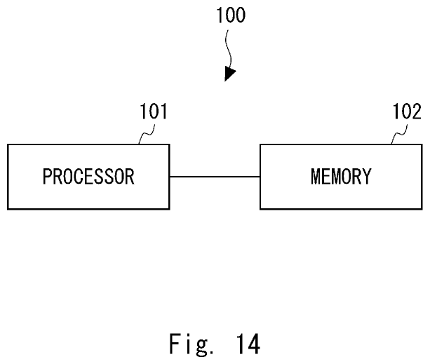

When a verification result from the condition verification unit 25 shows that the candidate parts configuration satisfies the condition (Yes in Step S109), the concretization processing unit 22A determines whether there is an unspecified part in the candidate parts configuration (Step S106). When there is an unspecified part in the candidate parts configuration (Yes in Step S106), the concretization processing unit 22A selects another type 2 concretization pattern (Step S107). By repeating the processing of Steps S106 to S109 in this manner, the concretization proceeds from the configuration state ST3 to the configuration state ST8 as shown in FIG. 13. The configuration state ST8 shows the candidate parts configuration that does not contain any unspecified part. Further, in the configuration state ST8, the total price of the parts is 146,000 yen, which is less than the budget of 150,000 yen, and therefore the condition is satisfied.

When there is no unspecified part in the candidate parts configuration (No in Step S106), the concretization processing unit 22A outputs the candidate parts configuration as the parts configuration plan to the output unit 26 (Step S111).

On the other hand, when a verification result from the condition verification unit 25 shows that the candidate parts configuration does not satisfy the condition (No in Step S109), the concretization processing unit 22A changes the candidate parts configuration back to the candidate parts configuration before application of the type 2 concretization pattern. Then, the process returns to Step S107.

As described above, according to the second example embodiment, in the parts configuration plan generation device 20, the concretization processing unit (first concretization unit) 22A concretizes the “abstract configuration” by using the type 1 concretization pattern, and thereby generates the “base parts configuration”. The concretization processing unit (second concretization unit) 22B applies the type 2 concretization pattern to the base parts configuration and concretizes the parts contained in this base parts configuration, and thereby generates the “candidate parts configuration”. The output unit 26 outputs the candidate parts configuration where concretization is done and which satisfies the condition to be satisfied by the device to be built as the “parts configuration plan”.

Since this configuration of the parts configuration plan generation device 20 eliminates the need for a user to individually specify parts, it reduces the burden on the user. Further, since it first concretizes the “abstract configuration” containing the request condition and then outputs the candidate parts configuration where concretization is done and which satisfies the condition to be satisfied by a device to be built as the “parts configuration plan”, it is capable of generating the parts configuration plan of the device to be built that satisfies the requests and conditions by the user.

In the parts configuration plan generation device 20, the concretization processing unit 22B may select the type 2 concretization pattern to be applied to the base parts configuration according to the priority, and apply the selected type 2 concretization pattern to the base parts configuration. The priority may be the priority of sales promotion (priority regarding sales promotion), for example.

This configuration of the parts configuration plan generation device 20 enables generation of the parts configuration plan in consideration of the circumstances of a parts shop. This thereby enables flexible generation of the parts configuration plan in view of the circumstances of a user.

### <Modified Example>

Although “additional information” such as parts specifying information is added as the “attribute information” to the parts item in the above description, the example embodiment is not limited thereto. For example, “additional information” such as parts specifying information may be used as a part of the “condition”.

### Other Example Embodiments

FIG. 14 is a view showing a hardware configuration example of a parts configuration plan generation device. In FIG. 14, a parts configuration plan generation device 100 includes a processor 101 and a memory 102. The processor 101 may be a microprocessor, an MPU (Micro Processing Unit) or a CPU (Central Processing Unit), for example. The processor 101 may include a plurality of processors. The memory 102 is a combination of a volatile memory and a nonvolatile memory. The memory 102 may include a storage that is placed apart from the processor 101. In this case, the processor 101 may access the memory 102 through an I(Input)/O(Output) interface, which is not shown.

Each of the parts configuration plan generation devices 10 and 20 according to the first and second example embodiments may have the hardware configuration shown in FIG. 14. The concretization unit 11, 22, the output unit 12, 26, the input unit 21, and the condition verification unit 25 of the parts configuration plan generation device 10, 20 according to the first and second example embodiments may be implemented by reading and executing, by the processor 101, a program stored in the memory 102. The concretization pattern registration DB 23 and the parts data registration DB 24 may be implemented by the memory 102. The program may be stored using various types of non-transitory computer readable media and supplied to the parts configuration plan generation device 10, 20. Examples of non-transitory computer readable media include magnetic storage media (such as flexible disks, magnetic tapes, hard disk drives, etc.), and optical magnetic storage media (e.g. magneto-optical disks). Examples of non-transitory computer readable media further include CD-ROM (Read Only Memory), CD-R, and CD-R/W. Examples of non-transitory computer readable media further include semiconductor memories. The semiconductor memories include mask ROM, PROM (Programmable ROM), EPROM (Erasable PROM), flash ROM, and RAM (Random Access Memory). The program may be provided to the parts configuration plan generation device 10, 20 using various types of transitory computer readable media. Examples of transitory computer readable media include electric signals, optical signals, and electromagnetic waves. Transitory computer readable media can provide the program to the parts configuration plan generation device 10, 20 via a wired communication line such as an electric wire or an optical fiber, or a wireless communication line.

The first and second example embodiments can be combined as desirable by one of ordinary skill in the art.

The present disclosure provides a parts configuration plan generation device, a parts configuration plan generation method, and a control program capable of generating a parts configuration plan of a device to be built that satisfies requests and conditions by a user with less burden on the user.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A parts configuration plan generation device comprising:
at least one memory storing instructions, and
at least one processor configured to execute, according to the instructions, a process including:
concretizing an abstract configuration containing an entry regarding a request for a device to be built by using a first concretization pattern in order to generate a base parts configuration;
second concretizing a parts item contained in the base parts configuration by applying a second concretization pattern to the base parts configuration in order to generate a candidate parts configuration; and
outputting, as a parts configuration plan, the candidate parts configuration satisfying a condition to be satisfied by the device to be built.

2. The parts configuration plan generation device according to claim 1, wherein the second concretizing includes:
selecting a second concretization pattern to be applied to the base parts configuration according to an order of priority, and
applying the selected second concretization pattern to the base parts configuration.

3. The parts configuration plan generation device according to claim 1, wherein the process further comprising:
verifying whether a candidate parts configuration satisfies a condition to be satisfied by the device to be built.

4. The parts configuration plan generation device according to claim 3, wherein the candidate parts configuration is output as a parts configuration plan when it is determined that the candidate parts configuration satisfies the condition.

5. The parts configuration plan generation device according to claim 1, wherein
the abstract configuration contains parts specifying information,
the concretizing includes adding the parts specifying information to a parts item contained in the base parts configuration as attribute information regarding the parts item, and
the second concretizing includes applying the second concretization pattern matching the attribute information to the base parts configuration.

6. The parts configuration plan generation device according to claim 3, wherein the condition includes at least one of specification of parts, a size, and a cost.

7. A parts configuration plan generation method comprising:
concretizing an abstract configuration containing an entry regarding a request for a device to be built by using a first concretization pattern in order to generate a base parts configuration;
concretizing a parts item contained in the base parts configuration by applying a second concretization pattern to the base parts configuration in order to generate a candidate parts configuration; and
outputting, as a parts configuration plan, the parts configuration plan satisfying a condition to be satisfied by the device to be built.

8. A non-transitory computer readable medium storing a control program causing a parts configuration plan generation device to execute a process comprising:
concretizing an abstract configuration containing an entry regarding a request for a device to be built by using a first concretization pattern in order to generate a base parts configuration;
concretizing a parts item contained in the base parts configuration by applying a second concretization pattern to the base parts configuration in order to generate a candidate parts configuration; and
outputting, as a parts configuration plan, the candidate parts configuration satisfying a condition to be satisfied by the device to be built.
